(19) United States
(12) Patent Application Publication
(10) Pub. No.: US 2002/0071960 A1
(43) Pub. Date: Jun. 13, 2002

(54) BIAXIALLY ORIENTED, MULTILAYER POLYPROPYLENE FILM, PROCESS FOR THE PRODUCTION THEREOF AND THE USE THEREOF

(76) Inventors: HERBERT PEIFFER, MAINZ (DE); URSULA MURSCHALL, NIERSTEIN (DE)

Correspondence Address: CONNOLLY BOVE LODGE & HUTZ, LLP, 1220 N MARKET STREET, P O BOX 2207, WILMINGTON, DE, 19899

(21) Appl. No.: 08/377,365

(22) Filed: Jan. 24, 1995

(30) Foreign Application Priority Data
Jan. 29, 1994 (DE) P 44 02 689.7

(51) Int. Cl. B32B 27/08; B32B 27/32

(52) U.S. Cl. 428/516; 428/523; 428/910; 428/35.2; 428/35.7; 428/36.5; 264/288.4; 264/290.2

(57) ABSTRACT

The disclosed biaxially oriented, multilayer polypropylene film comprises at least one base layer B, one interlayer Z and one top layer D and contains migrating additives. The film contains a maximum of 0.15% by weight of migrating additives, based on the total weight of the film. The multilayer film structure is produced by coextrusion and biaxial stretching followed by heat-setting and, optionally, corona treatment. The film is particularly useful in packaging and in laminates.

### FIELD OF THE INVENTION

The invention relates to a biaxially oriented, multilayer polypropylene film which comprises at least one base or innermost layer B, an interlayer Z and a top or outer layer D and which contains migrating additives.

### DESCRIPTION OF THE PRIOR ART

Biaxially oriented polypropylene (BOPP) films for the packaging sector can be divided roughly into two groups, the transparent films and the opaque or white films. In order to improve various film properties, all films contain migrating additives, such as, for example, antistatics, internal and external lubricants and release agents. These additives are either incorporated into the base layer or into the top layer.

Migrating additives are typically incompatible with propylene polymers. These additives can also have some degree of volatility and hence can evaporate from the outermost layers of the film during film processing and even form deposits on equipment. Some migrating additives are organic compounds with long-chain aliphatic radicals and hence can have wax-like properties. When deposits are formed on film processing equipment, these wax-like properties can be detrimental to further use of the equipment. Accordingly, migrating additives are to be contrasted with non-volatile, solid, generally inorganic additives such as most fillers, pigments, and inorganic anti-blocking agents such as finely-divided silica or silicates.

As a consequence of their incompatibility with the polymers of the base layer, the migrating additives, such as carboxamides, siloxanes or antistatics, diffuse to the film surface, where they develop their friction-reducing, anti-blocking or antistatic action. Since this migration requires a certain time, the incorporation of the additives into the base layer prevents evaporation of the substances, for example in stretching units during the film production process. In order to achieve the desired effects, it is necessary to provide a base layer, which is thick relative to the top layer, with migrating additives. The thickness of the base layers means that the amount of active components added is significantly greater than in the formulation of the top layer(s). In order to achieve an optimum coefficient to friction, a concentration of, for example, from 0.1 to 0.3% by weight, based on the weight of the base layer, of erucamide is incorporated into the base layer. In combination with heat-sealable and/or non-heat-sealable top layers which have been provided with an antiblocking agent, coefficients of friction of from 0.15 to 0.25 are achieved. Furthermore, in order to achieve good antistatic properties of the film, the base layer is additionally provided with antistatics (from 0.1 to 0.2% by weight).

The abovementioned additives are significantly more expensive than the polymer. This means that it is not economical to formulate the thick base layer with additives.

In order to reduce the amount of additives, based on the film as a whole, the additives are incorporated directly into the top layer(s). This improves the economics and reduces the overall migration of the additives, for example into foods. However, the incorporation of migrating additives directly into the top layer results in massive and variable, depending on the way in which the process is carried out, evaporation during film production. Consequently, frequent cleaning of the stretching units is necessary, since otherwise dripping-down of waxy deposits impairs the film properties, in particular the optical properties, and the machine clogs with wax-like materials. The amount of additives which evaporate depend on the way in which the process is carried out, so that a constant friction level and a constant antistatic behavior of the films cannot be achieved.

U.S. Pat. No. 4,419,410 describes a multilayer biaxially-oriented polypropylene (BOPP) film containing migrating additives in the base layer, whose base layer comprises a polypropylene of high stereoregularity and whose top layer is built up from a polypropylene of low stereoregularity. The low stereoregularity of the top layer is said to improve the migration of the additives from the base layer into the top layer. However, this type of film structure appears to require high concentrations of migrating additives, which additives are generally the most costly ingredient of the entire film structure.

U.S. Pat. No. 4,419,411 describes a multilayer BOPP film said to have good sliding properties and which has the layer structure mentioned in U.S. Pat. No. 4,419,410. In order to achieve good sliding friction, the base layer contains an incompatible amide and the top layer(s) contains a silicone oil as lubricant and a silicate as antiblocking agent. The silicone oil would appear to make corona treatment of the film more difficult since the silicone oil partially crosslinks during the corona treatment, and impairment of the heat-sealability and the sliding friction of the film can be expected.

U.S. Pat. No. 4,911,976 describes a multilayer BOPP film of the above structure which additionally contains an amine in the base layer, which amine is said to further improve the friction and achieve good antistatic finishing of the film. However, the additional additive does not appear to solve the problems of such films noted in the case of the discussion of U.S. Pat. No. 4,419,411.

EP-A-0 180 087 discloses a five-layer, opaque BOPP film said to have improved mechanical properties, in which, in order to achieve the good mechanical properties, the vacuole-free layer is built up from polypropylene and a hydrocarbon resin. These layers form the three-layer support film of the disclosed film. Glass-clear polyolefin layers are arranged on both sides of the support film. In order to achieve an adequate frictional behavior, the surfaces of the film are provided with an antiblocking agent. For contemporary applications on high-speed wrapping machines, however, it is important that the packaging film have a low coefficient of friction, and the coefficient of friction of the disclosed five-layer film appears to be relatively high.

EP-A-0 222 295 relates to a heat-sealable, transparent, multilayer film said to have superior scratch resistance. The film comprises a base layer of polypropylene and, on both sides, interlayers likewise of polypropylene, and two heat-sealable outer layers. In order to improve the scratch resistance, the interlayers contain an inorganic pigment and a hydroxyalkylamine. The two heat-sealable outer layers contain an olefin resin composition, a compatible low-molecular-weight resin, a propylene homopolymer and a silicone oil. Such outer layers appear to be poorly suited to printing.

U.S. Pat. No. 5,151,317 relates to a biaxially oriented, five-layer polyolefin film which can be heat-sealed on both sides, where the base layer essentially comprises propylene polymers, and the two heat-sealable layers essentially comprise heat-sealable olefin polymers. In order to improve the friction, the interlayers contain a silicone oil which has a viscosity of less than 500 mm²/s. Such low-viscosity silicone oils appear to volatilize easily and rapidly during film processing, and continual increases in loss of silicone oil due to volatilization, from processing step to processing step, can be expected to result in corresponding losses in low-friction properties of the film.

Thus, an important objective of the present invention is to maximize to greatest extent possible and in the most economical manner possible the efficiency of migrating additives while minimizing problems such as loss of such additives due to evaporation, loss of desired low-friction properties, lack of consistency in antistatic, release, or low-friction properties, formation of undesired deposits on film processing equipment, and the like. There is still a need for a biaxially oriented polypropylene film which has constant and, if desired, low friction and constant, if desired, good antistatic properties and which, in the case of packaging films, can easily be processed on high-speed packaging and processing machines. In the case of lamination films, it is also required that the film does not stick to and block the lamination drums. The film should have good gloss and, in the case of transparent embodiments, low haze. If necessary, the film should be highly suitable for corona treatment and should be readily printable. Furthermore, the film should have very low overall migration, in particular with respect to foods.

### SUMMARY OF THE INVENTION

The objectives of this invention are achieved by a multilayer polypropylene film of the generic type mentioned at the outset which contains an effective amount of one or a combination of migrating additives, where the maximum amount of migrating additive or additives is 0.15% by weight, based on the total weight of the film.

According to the invention, the film comprises at least three layers and comprises a base layer B and at least one interlayer Z and at least one top layer D, with the layer structure BZD.

For the purposes of the present invention, the base layer is the layer which has the greatest thickness and makes up at least 40%, preferably from 50 to 90%, of the total film thickness. Top layers are the layers which form the outer layers. Interlayers are naturally installed between other existing layers, generally between the base layer and a top layer.

In a preferred embodiment, the film comprises a base layer B, interlayers Z applied thereto on both sides, and top layers D applied to the interlayers, i.e. a five-layer symmetrical structure DZBZD. In a further preferred embodiment, the film comprises a base layer B, one interlayer Z applied thereto on one side, and top layers D applied to the base layer and the interlayer, i.e. DBZD. If desired, these basic structures comprising three, four or five layers can contain further interlayers.

The base layer of the film generally contains at least 70% by weight, preferably from 75 to 98% by weight, in particular from 80 to 95% by weight, in each case based on the base layer, of a propylene polymer described below.

### DETAILED DESCRIPTION

Throughout this description, the terms “propylene polymer” and “polypropylene” are used interchangeably, it being understood that a “propylene polymer” or a “polypropylene” can be a homopolymer or a copolymer (generally a copolymer having a major amount of propylene units), and a copolymer can have just two kinds of repeating units or can be a terpolymer, quaterpolymer, or the like.

Preferred propylene polymers contain at least 90% by weight, preferably from 94 to 100% by weight, in particular from 98 to 100% by weight, of propylene. The corresponding comonomer content of at most 10% by weight or from 0 to 6% by weight or from 0 to 2% by weight generally, if present, comprises ethylene. The % by weight data are in each case based on the propylene homopolymer.

Isotactic propylene homopolymer is preferred.

The propylene homopolymer of the base layer generally has a melting point of from 140 to 170° C., preferably from 150 to 165° C., and generally has a melt flow index (measurement DIN 53 735 at a load of 21.6 N and at 230° C.) of from 1.5 to 20 g/10 min, preferably from 2 to 15 g/10 min. The n-heptane-soluble content of the isotactic polymer is generally from 1 to 6% by weight, based on the polymer.

In a preferred embodiment of the novel film, the propylene polymer of the base layer is peroxidically degraded.

A measure of the degree of degradation of the polymer is the degradation factor A, which gives the relative change in the melt flow index, measured in accordance with DIN 53 735, of the polypropylene, based on the starting polymer.

MFI₁=melt flow index of the propylene polymer before addition of the organic peroxide.

MFI₂=melt flow index of the peroxidically degraded propylene polymer.

In general, the degradation factor A of the propylene polymer employed is in the range from 3 to 15, preferably from 6 to 10.

Particularly preferred organic peroxides are dialkyl peroxides, where the term alkyl radical is taken to mean a conventional saturated, straight-chain or branched lower alkyl radical having up to six carbon atoms. Particular preference is given to 2,5-dimethyl-2,5-di(t-butylperoxy)hexane and di-t-butyl peroxide.

In order to ensure the low additive content according to the invention of at most 0.15% by weight of migrating additives, it is particularly preferred that essentially no migrating additives, such as, for example, lubricants, antistatics and release agents be added to the base layer or layers.

In general, however, the base layer contains conventional stabilizers and neutralizers, in each case in effective amounts, and, if desired, hydrocarbon resin. In an optional embodiment, the base layer contains pigments and/or vacuole-inducing particles. All the % by weight data below are based on the weight of the base layer.

Stabilizers which can be employed are conventional compounds which have a stabilizing action for polymers of ethylene, propylene and other α-olefins. Their added amount is between 0.05 and 2% by weight. Particularly suitable are phenolic stabilizers, alkali metal or alkaline earth metal stearates and/or alkali metal or alkaline earth metal carbonates.

Preference is given to phenolic stabilizers having a molecular weight of greater than 500 g/mol in an amount of from 0.1 to 0.6% by weight, in particular from 0.15 to 0.3% by weight. Pentaerythrityl tetrakis-3-(3,5-di-tert-butyl-4-hydroxyphenyl)propionate and 1,3,5-trimethyl-2,4,6-tris(3,5-di-tert-butyl-4-hydroxybenzyl)benzene are particularly advantageous.

Neutralizers are preferably dihydrotalcite, calcium stearate and/or calcium carbonate having a mean particle size of at most 0.7 μm, an absolute particle size of less than 10 μm and a specific surface area of at least 40 m²/g.

The resin-modified embodiments of films of this invention contain the resin (generally a hydrocarbon resin) in an amount of from 1 to 20% by weight, preferably from 1 to 12% by weight, in particular from 1 to 10% by weight, based on the weight of the base layer.

Hydrocarbon resins are low-molecular weight polymers whose molecular weight is generally in the range from 300 to 8,000, preferably from 400 to 5,000, in particular from 500 to 2,000. The molecular weight of the resins is thus significantly lower than that of the propylene polymers which form the principal component of the individual film layers and generally have a molecular weight of greater than 100,000.

Preferred resins are hydrocarbon resins, which, if desired, can be partially or, preferably, fully hydrogenated. Suitable resins are basically synthetic resins or resins of natural origin. It has proven particularly advantageous to employ resins having a softening point of ≧80° C. (measured in accordance with DIN 1995-U4 or ASTM E-28), those having a softening point of from 100 to 180° C., in particular from 120 to 160° C., being preferred.

Of the numerous resins, preference is given to hydrocarbon resins in the form of petroleum resins, styrene resins, cyclopentadiene resins and terpene resins (these resins are described in Ullmanns Encyklopädie der techn. Chemie [Ullmann's Encyclopedia of Industrial Chemistry], 4th Edition, Volume 12, pages 525 to 555).

The petroleum resins are those hydrocarbon resins prepared by polymerization of deep-decomposed petroleum materials in the presence of a catalyst. These petroleum materials usually contain a mixture of resin-forming substances, such as styrene, methylstyrene, vinyltoluene, indene, methylindene, butadiene, isoprene, piperylene and pentylene. The styrene resins are homopolymers of styrene or copolymers of styrene with other monomers such as methylstyrene, vinyltoluene and butadiene. The cyclopentadiene resins are cyclopentadiene homopolymers or cyclopentadiene copolymers obtained from coal tar distillates and fractionated petroleum gas. These resins are prepared by keeping the materials containing cyclopentadiene at high temperature for a long time. Depending on the reaction temperature, dimers, trimers or oligomers can be obtained.

The terpene resins are polymers of terpenes, i.e. hydrocarbons of the formula C₁₀H₁₆, which are present in virtually all essential oils or oil-containing resins from plants, and phenol-modified terpene resins. Specific examples of terpenes which can be mentioned are pinene, α-pinene, dipentene, limonene, myrcene, camphene and similar terpenes. The hydrocarbon resins can also be so-called modified hydrocarbon resins. The modification is generally carried out by reaction of the raw materials before the polymerization, by the introduction of specific monomers or by reaction of the polymerized product, in particular by hydrogenation or partial hydrogenation.

The hydrocarbon resins employed are also styrene homopolymers, styrene copolymers, cyclopentadiene homopolymers, cyclopentadiene copolymers and/or terpene polymers having a softening point of in each case above 120° C. (in the case of unsaturated polymers, the hydrogenated product is preferred). Very particular preference is given in the base layer to cyclopentadiene polymers having a softening point of at least 125° C. or copolymers of α-methylstyrene and vinyltoluene having a softening point of from 110 to 160° C.

In a white or opaque or white/opaque embodiment, the base layer additionally contains pigments or vacuole-inducing particles or a combination thereof. Such films have a light transparency measure in accordance with ASTM-D 1033-77 of at most 50%, preferably at most 70%.

Pigments include particles which result in essentially no vacuole formation on stretching. The coloring action of the pigments is caused by the particles themselves. The term “pigment” is generally associated with a particle size of from 0.01 to a maximum of 1 μm and covers both so-called “white pigments”, which color the films white, and “colored pigments” which give the film a colored or black color. In general, the mean particle diameter of the pigments is in the range from 0.01 to 1 μm, preferably from 0.01 to 0.7 μm, in particular from 0.01 to 0.4 μm. The base layer generally contains pigments in an amount of from 1 to 25% by weight, in particular from 2 to 20% by weight, preferably from 5 to 15% by weight, in each case based on the base layer.

Conventional pigments are materials such as, for example, aluminum oxide, aluminum sulfate, barium sulfate, calcium carbonate, magnesium carbonate, silicates, such as aluminum silicate (kaolin clay) and magnesium silicate (talc), silicon dioxide and titanium dioxide, of which white pigments, such as calcium carbonate, silicon dioxide, titanium dioxide and barium sulfate are preferred.

The titanium dioxide particles comprise at least 95% by weight of rutile and are preferably employed with a coating of inorganic oxides, as usually used as a coating for TiO₂ white pigment in papers or paints in order to improve the light fastness. Particularly suitable inorganic oxides include the oxides of aluminum, silicon, zinc and magnesium or mixtures of two or more of these compounds. They are precipitated from water-soluble compounds, for example alkali metal aluminate, in particular sodium aluminate, aluminum hydroxide, aluminum sulfate, aluminum nitrate, sodium silicate or silicic acid, in aqueous suspension. Coated TiO₂ particles are described, for example, in EP-A-0 078 633 and EP-A-0 044 515.

The coating can optionally contain organic compounds containing polar and nonpolar groups. Preferred organic compounds are alkanols and fatty acids having 8 to 30 carbon atoms in the alkyl group, in particular fatty acids and primary n-alkanols having 12 to 24 carbon atoms, and polydiorganosiloxanes and/or polyorganohydrosiloxanes, such as polydimethylsiloxane and polymethylhydrosiloxane.

The coating on the TiO₂ particles usually comprises from 1 to 12 g, in particular from 2 to 6 g, of inorganic oxides, if desired additionally from 0.5 to 3 g, in particular from 0.7 to 1.5 g, of organic compounds, in each case based on 100 g of TiO₂ particles. It has proven particularly advantageous for the Tio₂ particles to be coated with Al₂O₃ or with Al₂O₃ and polydimethylsiloxane.

Opaque embodiments of the films contain vacuole-inducing particles which are incompatible with the polymer matrix and result in the formation of vacuole-like cavities when the film is stretched, the size, type and number of the vacuoles being dependent on the material and on the size of the solid particles and the stretching conditions, such as stretching ratio and stretching temperature. The vacuoles give the films a characteristic pearl-like opaque appearance, caused by light scattering at the vacuole-polymer matrix interfaces. In general, the mean particle diameter of the vacuole-inducing particles is from 1 to 6 μm, preferably from 1.5 to 5 μm. The base layer generally contains vacuole-inducing particles in an amount of from 1 to 25% by weight.

Conventional vacuole-inducing particles in the base layer are inorganic and/or organic, polypropylene-incompatible materials, such as aluminum oxide, aluminum sulfate, barium sulfate, calcium carbonate, magnesium carbonate, silicates, such as aluminum silicate (kaolin clay) and magnesium silicate (talc), silicon dioxide and titanium dioxide, of which calcium carbonate, silicon dioxide and titanium dioxide are preferred. Suitable organic fillers are the conventional polymers which are incompatible with the polymers of the base layer, in particular those such as HDPE, polyesters, polystyrenes, polyamides and halogenated organic polymers, preference being given to polyesters, such as, for example polybutylene terephthalates or polyethylene terephthalates. For the purposes of the present invention, “incompatible materials or incompatible polymers” is taken to mean that the material or polymer is in the form of a separate particle or a separate phase in the film.

White/opaque films provided with vacuole-inducing particles and with pigment contain the vacuole-inducing particles in an amount of from 1 to 10% by weight, preferably from 1 to 5% by weight, and pigment in an amount of from 1 to 7% by weight, preferably from 1 to 5% by weight.

The density of the opaque or white films can vary within broad limits and depends on the type and amount of fillers. The density is generally in the range from 0.4 to 1.1 g/cm³.

Pigmented films have a density in the order of 0.9 g/cm³ or above, preferably in the range from 0.9 to 1.1 g/cm³.

Films containing only vacuole-inducing particles have a density of less than 0.9 g/cm³. For packaging films having a content of vacuole-inducing particles of from 2 to 5% by weight, the density is in the range from 0.6 to 0.85 g/cm³. For films having a content of vacuole-inducing particles of from 5 to 14% by weight, the density is in the range from 0.4 to 0.8 g/cm³.

Films containing pigments and vacuole-inducing particles have a density in the range from 0.5 to 0.85 g/cm³, depending on the ratio between the pigment content and the content of vacuole-inducing particles.

The novel polypropylene film furthermore comprises at least one interlayer of polymers of α-olefins containing 2 to 10 carbon atoms which is applied to the base layer.

Examples of such α-olefinic polymers are α-olefin homopolymers and copolymers (including two-unit copolymers, terpolymers, etc.), such as

a propylene homopolymer or

a two-unit copolymer of

ethylene and propylene or

ethylene and 1-butylene or

propylene and 1-butylene or

a terpolymer of

ethylene and propylene and 1-butylene or

a mixture of two or more of said homopolymers, two-unit copolymers and terpolymers or

a blend of two or more of said homopolymers, two-unit copolymers and terpolymers, if desired mixed with one or more of said homopolymers, two-unit copolymers and terpolymers,

particular preference being given to propylene homopolymer or random ethylene-propylene copolymers having

an ethylene content of from 1 to 10% by weight, preferably from 2.5 to 8% by weight or random propylene-1-butylene copolymers having

a butylene content of from 2 to 25% by weight, preferably from 4 to 20% by weight,

in each case based on the total weight of the copolymer, or random ethylene-propylene-1-butylene terpolymers having

an ethylene content of from 1 to 10% by weight, preferably from 2 to 6% by weight, and

a 1-butylene content of from 2 to 20% by weight, preferably from 4 to 20% by weight,

in each case based on the total weight of the terpolymer, or

a blend of an ethylene-propylene-1-butylene terpolymer and a propylene-1-butylene copolymer

having an ethylene content of from 0.1 to 7% by weight and a propylene content of from 50 to 90% by weight and a 1-butylene content of from 10 to 40% by weight, in each case based on the total weight of the polymer blend.

The propylene homopolymer employed in the interlayer comprises predominantly (at least 90%) propylene and generally has a melting point of 140° C. or above, preferably from 150 to 170° C., preference being given to isotactic homopolypropylene having an n-heptane-soluble content of 6% by weight or less, based on the isotactic homopolypropylene. The homopolymer generally has a melt flow index of from 1.5 g/10 min to 20 g/10 min, preferably from 2.0 g/10 min to 15 g/10 min.

The above-described copolymers and terpolymers employed in the interlayer generally have a melt flow index of from 1.5 to 30 g/10 min, preferably from 3 to 15 g/10 min. The melting point is preferably in the range from 120 to 140° C. The above-described blend of copolymers (including terpolymers) has a melt flow index of from 5 to 9 g/10 min and a melting point of from 120 to 150° C. All the melt flow indices given above are measured at 230° C. and a force of 21.6 N (DIN 53 735).

The melt flow indices of the polymers for the base layer and interlayer(s) are advantageously as similar as possible. If desired, the MFI of the interlayer can be somewhat higher, but the difference should not be more than 20%, preferably from 2 to 10%.

If desired all the interlayer polymers described above can be peroxidically degraded in the same way as described above for the base layer, basically the same peroxides being used. The degradation factor for the interlayer polymers is generally in the range from 3 to 15, preferably from 6 to 10.

The novel film contains a maximum of 0.15% by weight of migrating additives, based on the total weight of the film. This amount of additive is preferably added exclusively to the interlayer(s), preferably with substantial exclusion of such additives from the base layers and top or outer layers. Surprisingly, this allows the absolute amount of migrating additives in the film to be greatly reduced without impairing the film quality.

The interlayer generally contains from 0.1 to 3% by weight, preferably from 0.5 to 2% by weight of lubricants and/or from 0.1 to 3% by weight, preferably from 0.5 to 2% by weight, of antistatics and/or from 0.1 to 3% by weight, preferably from 0.5 to 2% by weight, of release agents, in each case based on the weight of the interlayer, where the amount of lubricants and/or antistatics and/or release agents must be selected in accordance with the invention in such way that the film contains a total of up to 0.15% by weight, preferably from 0.005 to 0.3% by weight, in particular from 0.01 to 0.1% by weight, of migrating additives, such as lubricants and/or antistatics and/or release agents, in each case based on the total weight of the film.

Preferred lubricants include higher aliphatic acid amides, higher aliphatic acid esters, low-molecular-weight waxes and metal soaps, and silicone oils. Particularly suitable is the addition of higher aliphatic acid amides and silicone oils.

Aliphatic acid amides are amides of a water-insoluble monocarboxylic acid (known as a fatty acid) having 8 to 24 carbon atoms, preferably 10 to 18 carbon atoms. Erucamide, stearamide and oleamide are preferred.

Suitable silicone oils are polydialkylsiloxanes, preferably polydimethylsiloxane, polymethylphenylsiloxane, olefin-modified silicone, polyether-modified silicone, such as, for example, polyethylene glycol and polypropylene glycol, and epoxyamino- and alcohol-modified silicone. The viscosity of the suitable silicone oils is in the range from 5,000 to 1,000,000 mm²/s. Polydimethylsiloxane having a viscosity of from 10,000 to 100,000 mm^{2/}s is preferred.

Preferred antistatics are the essentially straight-chain and saturated aliphatic, tertiary amines containing an aliphatic radical having 10 to 20 carbon atoms which are substituted by ω-hydroxy-(C₁-C₄)-alkyl groups, where N,N-bis-(2-hydroxyethyl) alkylamines having 10 to 20 carbon atoms, preferably 12 to 18 carbon atoms, in the alkyl radical are particularly suitable. Other suitable antistatics are monoesters of glycerol and aliphatic fatty acids, preference being given to fatty acid radicals having 10 to 20 carbon atoms. Glycerol monostearate is particularly preferred.

In a preferred embodiment, at least one interlayer contains a combination of lubricants and antistatics and/or release agents, preference being given to a combination of higher aliphatic acid amides and tertiary aliphatic amines or a combination of silicone oil and tertiary aliphatic amines or a combination of release agents and tertiary aliphatic amines. In this case, the interlayer preferably contains from 0.5 to 2% by weight of amides and from 0.5 to 2% by weight of amines, in each case based on the weight of the interlayer.

Preferably, the film interlayer or interlayers contain or contains no vacuole-inducing fillers, so that essentially no vacuoles are produced in the interlayer during stretching of the film. It has been found that the advantages of the invention are impaired in the case of a vacuole-containing interlayer, i.e. the migrating additives do not develop their action in the proposed manner and not in the desired extent in a vacuole-containing interlayer. In particular, the constant antistatic and frictional properties are no longer ensured. It is therefore greatly preferred that all interlayers be essentially free of vacuoles.

If desired, however, the interlayer (or interlayers) can additionally contain pigments which produce essentially no vacuoles, and/or a hydrocarbon resin.

The pigments employed are the particles described above as pigments for the base layer, particular preference being given to TiO₂ as pigment for the interlayer. The interlayer generally can contain from 1 to 20% by weight, preferably from 2 to 10% by weight, of pigments, in each case based on the weight of the interlayer.

The hydrocarbon resins employed are the resins described above for the base layer. The interlayer generally can contain from 1 to 15% by weight, preferably from 1 to 12% by weight, in particular from 1 to 10% by weight, of resin, in each case based on the weight of the interlayer.

The interlayers furthermore preferably additionally contain the stabilizers and neutralizers described for the base layer in the corresponding amounts based on the weight of the interlayer.

The thickness of each interlayer is generally in a range of from 0.2 to 5 μm, preferably in the range from 0.4 to 3 μm.

The novel polypropylene film furthermore comprises at least one top layer(s) of polymers of α-olefins having 2 to 10 carbon atoms, preferably applied to both sides.

Examples of such α-olefinic polymers are α-olefin homopolymers and copolymers (including two-unit copolymers, terpolymers, etc.), such as

a propylene homopolymer or

a two-unit copolymer of

ethylene and propylene or

ethylene and 1-butylene or

propylene and 1-butylene or

a terpolymer of

ethylene and propylene and 1-butylene or

a mixture of two or more of said homopolymers, two-unit copolymers and terpolymers or

a blend of two or more of said homopolymers, two-unit copolymers and terpolymers, if desired mixed with one or more of said homopolymers, two-unit copolymers and terpolymers,

particular preference being given to propylene homopolymer or random ethylene-propylene copolymers having

an ethylene content of from 1 to 10% by weight, preferably from 2.5 to 8% by weight or random propylene-1-butylene copolymers having

a butylene content of from 2 to 25% by weight, preferably from 4 to 20% by weight,

in each case based on the total weight of the copolymer, or random ethylene-propylene-1-butylene terpolymers having

an ethylene content of from 1 to 10% by weight, preferably from 2 to 6% by weight, and

a 1-butylene content of from 2 to 20% by weight, preferably from 4 to 20% by weight,

in each case based on the total weight of the terpolymer, or

a blend of an ethylene-propylene-1-butylene terpolymer and a propylene-1-butylene copolymer

having an ethylene content of from 0.1 to 7% by weight and a propylene content of from 50 to 90% by weight and a 1-butylene content of from 10 to 40% by weight, in each case based on the total weight of the polymer blend.

The propylene homopolymer employed in the top layer of non-heat-sealable embodiments of the film comprises predominantly (at least 90%) propylene and generally has a melting point of 140° C. or above, preferably from 150 to 170° C., preference being given to isotactic homopolypropylene having an n-heptane-soluble content of 6% by weight or less, based on the isotactic homopolypropylene. The homopolymer generally has a melt flow index of from 1.5 g/10 min to 20 g/10 min, preferably from 2.0 g/10 min to 15 g/10 min.

The above-described copolymers and terpolymers employed in the top layer of heat-sealable embodiments of the film generally have a melt flow index of from 1.5 to 30 g/10 min, preferably from 3 to 15 g/10 min. The melting point is preferably in the range from 120 to 140° C. The above-described blend of copolymers and terpolymers has a melt flow index of from 5 to 9 g/10 min and a melting point of from 120 to 150° C. All the melt flow indices given above are measured at 230° C. and a force of 21.6 N (DIN 53 735).

If desired all the top layer polymers described above can be peroxidically degraded in the same way as described above for the base layer, basically the same peroxides being used. The degradation factor for the top layer polymers is generally in the range from 3 to 15, preferably from 6 to 10.

In a matt embodiment the top layer additionally contains a high-density polyethylene (HDPE), which is mixed or blended with the above-described top layer polymers. The composition of and details on the matt top layers are described, for example, in German Patent Application P 43 13 430.0, which is expressly incorporated herein by way of reference.

In order to guarantee the low additive content according to the invention of maximum of 0.15% by weight of migrating additives, it is advantageous if essentially no resin, no higher aliphatic acid amide and no tertiary aliphatic amine are added to the top layer. In a preferred embodiment, the top layers also contain essentially no release agents and no wax. However, the top layers generally contain stabilizers and neutralizers as described above for the base layer and interlayer, in the corresponding amounts based on the weight of the top layer. In a preferred embodiment, the top layers contain antiblocking agents described below.

Suitable antiblocking agents are solid, non-volatile inorganic additives, such as silicone dioxide, calcium carbonate, magnesium silicate, aluminum silicate, calcium phosphate and the like and/or incompatible organic polymers, such as polyamides, polyesters, polycarbonates and the like; preference is given to benzoguanamine-formaldehyde polymers, silicone dioxide and calcium carbonate. The effective amount of antiblocking agent, preferably SiO₂, is in the range from 0.1 to 2% by weight, preferably from 0.1 to 0.8% by weight. The mean particle size is between 1 and 6 μm, in particular between 2 and 5 μm, the particles having a spherical shape, as described in EP-A-0 236 945 and DE-A-38 01 535, being particularly suitable.

The thickness of the top layer(s) is generally greater than 0.2 μm and is preferably in the range from 0.4 to 2 μm, in particular from 0.5 to 1.5 μm.

The total thickness of the novel polypropylene film can vary within broad limits and depends on the intended use. It is preferably from 4 to 150 μm, in particular from 5 to 120 μm, especially from 6 to 100 μm, where the base layer makes up from about 40 to 95% of the total film thickness.

The invention furthermore relates to a process for the production of the novel polypropylene film by the coextrusion process known per se.

In this process, first, as is customary in coextrusion, the polymer or polymer mixture of the individual layers is compressed and liquefied in an extruder, it being possible for any additives already added to be present in the polymer or in the polymer mixture. The melts are then pressed simultaneously through a flat-film die (slot die), and the extruded multilayer film is drawn off over one or more take-off rolls, where it cools and solidifies.

The resultant film is then stretched longitudinally and transversely to the extrusion direction, which results in alignment of the molecule chains. The longitudinal stretching is expediently carried out with the aid of two rolls running at different speeds corresponding to the desired stretching ratio, and the transverse stretching is expediently carried out with the aid of an appropriate tenter frame. The longitudinal stretching ratios are in the range from 5.0 to 9, preferably from 5.5 to 8.5. The transverse stretching ratios are in the range from 5.0 to 9.0, preferably from 6.5 to 9.0.

Biaxial stretching of the film is followed by heat setting, the film being kept at a temperature of from 60 to 160° C. for about 0.1 to 20 seconds. The film is subsequently wound up in the conventional manner by means of a wind-up unit.

It has proven particularly favorable to keep the take-off roll or rolls, by means of which the extruded film is cooled and solidified, at a temperature of from 10 to 100° C., preferably from 20 to 70° C., by means of a heating and cooling circuit.

The temperatures at which longitudinal and transverse stretching are carried out can vary in a relatively broad range and depend on the desired properties of the film. In general, the longitudinal stretching is preferably carried out at from 80 to 150° C. and the transverse stretching preferably at from 120 to 170° C.

One or both surfaces of the film preferably is (are) corona- or flame-treated by one of the known methods after the biaxial stretching. The treatment intensity is generally in the range from 36 to 50 mN/m, preferably from 38 to 45 mN/m.

In the case of corona treatment an expedient procedure is to pass the film between two conductor elements serving as electrodes, such a high voltage, usually alternating voltage (from about 5 to 20 kV and from 5 to 30 kHz), being applied between the electrodes that spray or corona discharges can occur. The spray or corona discharge ionizes the air above the film surface and this ionized air reacts with the molecules of the film surface, causing formation of polar inclusions in the essentially non-polar polymer matrix.

For flame treatment with a polarized flame (cf. U.S. Pat. No. 4,622,237), a direct electric voltage is applied between a burner (negative pole) and a chill roll. The level of the applied voltage is between 400 and 3,000 V, preferably in the range from 500 to 2,000 V. The applied voltage gives the ionized atoms increased acceleration, and they hit the polymer surface with greater kinetic energy. The chemical bonds within the polymer molecule are more easily broken, and formation of free radicals proceeds more rapidly. Heating of the polymer here is substantially less than in the case of standard flame treatment, and films can be obtained in which the heat-sealing properties of the treated side are even better than those of the untreated side.

Multilayer films of this invention are distinguished by their excellent suitability as packaging and lamination films. It has been found that the multilayer structure in combination with the specific formulation of the individual layers ensures the advantageous action of the additives known per se, but at the same time their disadvantageous action is avoided.

Surprisingly, the exclusive formulation of the interlayer with migrating additives is sufficient to achieve constant and, if desired, good sliding properties and constant and, if desired, good antistatic properties of the film. It has been found that in this way essentially smaller absolute amounts of migrating additives are necessary. This means considerable economic advantages without the need to accept reductions in quality.

Surprisingly, the corresponding additives need additionally to be added to neither the base layer nor the top layer in order to guarantee the desired film properties.

It has been found that the conventional evaporation, as occurs during formulation of the top layers, is avoided by the multilayer film structure of this invention. The film is distinguished by very constant coefficients of friction and low migration values.

In addition, the film is highly suitable for corona treatment, since no interfering additives are present in the top layer at the time of corona treatment.

The invention is of considerable importance for vacuole-containing films. In this film type, the relatively small amounts of additives according to the invention can develop a surprisingly good action in spite of the vacuole-containing base layer. Conventional vacuole-containing films, in which additives have been added to the base layer, require considerably larger amounts of additive than transparent films since the vacuoles produce an internal surface to which the additives likewise migrate. However, the additives can only develop their action at the outer film surface, so that the proportion of the additives which migrate to the inner surface remains ineffective. The improvements achieved by the film structure and formulation of this invention are therefore even more pronounced than in transparent films.

The invention is described in greater detail by means of the illustrative, non-limiting Examples which follow.

### EXAMPLE 1

A transparent five-layer film having a symmetrical structure and a total thickness of 30 μm was produced by coextrusion followed by stepwise orientation in the longitudinal and transverse directions. The interlayers each had a thickness of 3 μm, and the top layers each had a thickness of 0.5 μm. The total content of migrating additives in the film was 0.08% by weight, based on the total weight of the film.

Base layer B:

| | | |
|---|---|---|
| 100% | by weight | of isotactic polypropylene from Solvay with the |
| | | trade name ® PHP 405 |

Interlayers Z:

| | | |
|---|---|---|
| 99.6% | by weight | of isotactic polypropylene from Solvay with |
| | | the trade name ® PHP 405 |
| 0.2% | by weight | of N,N-bis-ethoxyalkylamine |
| 0.2% | by weight | of erucamide |

Top layers D:

| | | |
|---|---|---|
| 99.7% | by weight | of random ethylene-propylene copolymer having |
| | | a C₂-content of 4.5% by weight |
| 0.3% | by weight | of SiO₂ having a mean particle size of 3 μm as |
| | | antiblocking agent |

The production conditions in the individual process steps were:

| Extrusion: Temperatures: | Layer A | 290° C. |
|---|---|---|
| | Layers B | 280° C. |
| | Layers C | 280° C. |
| | Take-off roll temperature | 30° C. |
| Longitudinal stretching: | Temperature | 130° C. |
| | Longitudinal stretching ratio | 5.0 |
| Transverse stretching: | Temperature | 160° C. |
| | Transverse stretching ratio | 10.0 |
| Heat setting: | Temperature | 110° C. |
| | Convergence | 20% |

The film had advantages during the production and was distinguished by excellent properties:

no evaporation of the additives in the stretching units

no deposition on rolls

low costs for the additives

### EXAMPLE 2

As in Example 1, a five-layer white film having a total thickness of 30 μm was produced with interlayer thicknesses of 3 μm in each case and with top layer thicknesses of 0.5 μm in each case. The total content of migrating additives in the film was 0.08% by weight, based on the total weight of the film. The raw material composition for the base layer, the interlayers and the top layers were now as follows:

Base layer B:

| | | |
|---|---|---|
| 96% | by weight | of isotactic polypropylene from Solvay with the |
| | | trade name ® PHP 405 |
| 4% | by weight | of calcium carbonate having a mean particle size of |
| | | 1.5 μm |

Interlayers Z:

| | | |
|---|---|---|
| 94.6% | by weight | of isotactic polypropylene from Solvay with |
| | | the trade name ® PHP 405 |
| 5.0% | by weight | of rutile-type titanium dioxide having a mean |
| | | particle size of 0.25 μm |
| 0.2% | by weight | of N,N-bis-ethoxyalkylamine |
| 0.2% | by weight | of erucamide |

Top layers D:

| | | |
|---|---|---|
| 99.7% | by weight | of random ethylene-propylene copolymer having |
| | | a C₂-content of 4.5% by weight |
| 0.3% | by weight | of SiO₂ having a mean particle size of 3 μm as |
| | | antiblocking agent |

Only the conditions in longitudinal and transverse stretching were changed:

| Longitudinal stretching: | Temperature | 290° C. |
|---|---|---|
| | Longitudinal stretching ratio | 5.5 |
| Transverse stretching: | Temperature | 155° C. |
| | Transverse stretching ratio | 9.5 |

### EXAMPLE 3

In contrast to Example 2, the film now additionally contained a low-molecular-weight hydrocarbon resin from Exxon in the interlayers. The name of the resin is ®ECR 356 and was provided in the form of a 50% strength by weight masterbatch. The proportion by weight of the hydrocarbon resin in the interlayers was about 20%. The stretching conditions were identical to those in Example 2. The film was distinguished by improved rigidity.

The raw materials and films were characterized using the following measurement methods:

Printability

The corona-treated films were printed 14 days after production (short-term assessment) and 6 months after production (long-term assessment). The ink adhesion was assessed by an adhesive-tape test. If little ink was removable by means of an adhesive tape, the ink adhesion was assessed as being moderate, and if a significant amount of ink was removed, it was assessed as being poor.

Tear Strength, Elongation at Break

The tear strength and elongation at break are determined in accordance with DIN 53455.

Determination of the Warm Blocking Behavior

In order to measure the warm blocking behavior, two match sticks measuring 72 mm×41 mm×13 mm to which felt is stuck on one side are wrapped in the film to be measured, and the pack is heat-sealed. A weight of 200 g is placed on the match sticks, which are positioned with the felt pads facing one another, and this arrangement is placed in a heating oven preheated to 70° C., where it is left for 2 hours. It is then cooled at room temperature (21° C.) for 30 minutes, the weight is removed from the match sticks, and the upper match stick is removed from the lower match stick by means of a mechanical apparatus. The assessment is carried out by means of 4 individual measurements, via which a maximum separation force (measured in N) is determined. The specification is satisfied if none of the individual measurements is above 5 N.

Melt Flow Index

The melt flow index was measured in accordance with DIN 53 735 at a load of 21.6 N and 230° C.

Coefficient of Friction

The coefficient of friction of the film was measured in accordance with DIN 53 375.

Melting Point

DSC measurement, maximum of the melting curve, heating rate 20° C./min.

Haze

The haze of the film was measured in accordance with ASTM-D 1003-52.

Gloss

The gloss was determined in accordance with DIN 67 530. The reflector value was measured as an optical parameter for the surface of a film. In accordance with the standards ASTM-D 523-78 and ISO 2813, the angle of incidence was set at 60° or 85°. A light beam hits the planar test surface at the set angle of incidence and is reflected or scattered by it. The light beams incident on the photoelectronic receiver are displayed as a proportional electrical quantity. The measurement value is dimensionless and must be specified together with the angle of incidence.

Surface Tension

The surface tension was determined by means of the ink method (DIN 53 364).

What is claimed is:

1. A biaxially oriented, multilayer polypropylene film comprising at least one base layer B, at least one interlayer Z and at least one top layer D and containing an effective amount of at least one migrating additive, the total amount of migrating additive or additives being not more than 0.15% by weight, based on the total weight of the film.

2. A multilayer polypropylene film as claimed in claim 1, wherein said base layer or layers is or are essentially free of migrating lubricant additives and migrating antistatic additives.

3. A multilayer polypropylene film as claimed in claim 2, wherein said top layer or layers is or are essentially free of hydrocarbon resin, tertiary aliphatic amine, and amide of a long-chain fatty acid.

4. A multilayer polypropylene film as claimed in claim 3, which contains from 0.005 to 0.15% by weight of a lubricant or from 0.005 to 0.15% by weight of an antistatic additive or from 0.005 to 0.15% by weight of a lubricants and an antistatic additive, in each case based on the total weight of the film, and the coefficient of friction of the film, measured in accordance with DIN 53 375, is <0.4.

5. A multilayer polypropylene film as claimed in claim 3, wherein the film comprises a base layer B and interlayers Z applied thereto on one or both sides, and top layers D applied to the base layer B and the interlayer Z or the interlayers Z.

6. A multilayer polypropylene film as claimed in claim 3, wherein the top layer or layers contains or contain a non-volatile, inorganic antiblocking agent.

7. A multilayer polypropylene film as claimed in claim 3, wherein the base layer or layers consist essentially of a propylene homopolymer whose MFI is from 1.5 to 20 g/10 min and whose melting point is from 140 to 165° C.

8. A multilayer polypropylene film as claimed in claim 7, wherein the propylene polymer of a said base layer has been peroxidically degraded.

9. A multilayer polypropylene film as claimed claim 3, wherein a said base layer contains vacuole-inducing particles or a pigment or a combination of vacuole-inducing particles and a pigment.

10. A multilayer polypropylene film as claimed in claim 3, wherein the base layer contains a hydrocarbon resin.

11. A multilayer polypropylene film as claimed in claim 3, wherein the interlayer or interlayers comprises or comprise a propylene polymer.

12. A multilayer polypropylene film as claimed in claim 11, wherein the propylene polymer of a said interlayer has been peroxidically degraded.

13. A multilayer polypropylene film as claimed in claim 11, wherein a said interlayer contains hydrocarbon resin or pigment or hydrocarbon resin and pigment.

14. A multilayer polypropylene film as claimed in claim 3, wherein the top layer or layers comprises or comprise a propylene polymer.

15. A biaxially oriented, multilayer propylene polymer film comprising:
at least one base layer, said base layer consisting essentially of a propylene polymer and being essentially free of migrating, volatile, lubricating, and waxy additives, but optionally containing a hydrocarbon resin, a pigment, vacuole-inducing particles or a combination thereof,
at least one interlayer comprising a propylene polymer and at least one static-reducing, lubricating, or anti-blocking amount of a migrating additive, or a combination of said additives, a said interlayer optionally containing a hydrocarbon resin or a pigment or a combination of a hydrocarbon resin and a pigment,
at least one outer layer containing a propylene polymer, said outer layer being essentially free of hydrocarbon resin and migrating, volatile, lubricating, and waxy additives, the maximum total amount of migrating additive or migrating additives in said film being 0.15% by weight, based on the total weight of the film, and the coefficient of friction of the outermost surfaces of said film, measured in accordance with DIN 53 375, being <0.4.

16. A multilayer propylene polymer film as claimed in claim 15, which contains from 0.005 to 0.15% by weight of a lubricant or from 0.005 to 0.15% by weight of an antistatic additive or from 0.005 to 0.15% by weight of a lubricant and an antistatic additive, in each case based on the total weight of the film.

17. A process for the production of a multilayer polypropylene film as claimed in claim 1, in which melts corresponding to the individual layers of the film are coextruded through a flat-film die, the resulting coextruded film is taken off over a take-off roll whose temperature is between 10 and 100° C., said resulting coextruded film is then biaxially stretched at a longitudinal stretching ratio of from 5:1 to 9:1 and a transverse stretching ratio of from 5:1 to 9:1, and the resulting biaxially stretched film is heat-set and, optionally, corona-treated and subsequently wound up.

18. A package or laminated structure wherein the package or laminated structure comprises, as the packaging film or as a lamina of said laminated structure, a multilayer polypropylene film as claimed in claim 1.
